(19) United States
(12) Patent Application Publication
(10) Pub. No.: US 2002/0006519 A1
(43) Pub. Date: Jan. 17, 2002

(54) Lubricated sheet product and lubricant composition

(76) Inventors: James R. Anglin, Export, PA (US); Donald R. Smith, Gibsonia, PA (US)

Correspondence Address: ALCOA INC, ALCOA TECHNICAL CENTER, 100 TECHNICAL DRIVE, ALCOA CENTER, PA, 15069-0001, US

(21) Appl. No.: 09/800,247

(22) Filed: Mar. 6, 2001

Related U.S. Application Data
(63) Continuation-in-part of application No. 09/396,624, filed on Sep. 15, 1999, now abandoned.
Application No. 09/396,624 is a continuation-in-part of application No. 09/079,775, filed on May 15, 1998, now abandoned.

(51) Int. Cl. B32B 15/04; C10G 71/00

(52) U.S. Cl. 428/457; 208/19

(57) ABSTRACT

There is disclosed a metal sheet product, more particularly formed food container stock and/or industrial sheet product, which has been treated with a lubricant composition having a vegetable oil portion which is less than about 60% monounsaturate in character, said composition comprising: (a) about 10-90 wt. % of a technical white mineral oil, preferably a polyalphaolefin, and/or white mineral oil, said component having an average molecular weight greater than about 400; and (b) about 10-90 wt. % of an edible vegetable oil selected from the group consisting of: safflower oil, canola oil, sunflower oil, corn oil, olive oil, cottonseed oil and combinations thereof. Preferably, the latter additive is a combination of about 8-20 wt. % safflower oil and about 25-50 wt. % canola oil. When applied in total deposited weights of about 0.1-30 mg/ft² per side, this invention produces formed container stock or industrial sheet products having improved formability and a reduced tendency to loosen or soften smudge residues on the sheet product itself.

### CROSS REFERENCE TO RELATED APPLICATIONS

This application is a continuation-in-part of application Ser. No. 09/396,624, filed on Sep. 15, 1999, which is a continuation-in-part of application Ser. No. 09/079,775, filed on May 15, 1998, both disclosures of which are fully incorporated by reference herein.

### BACKGROUND OF THE INVENTION

1. Field of the Invention

This invention relates to the lubrication of metal sheet product, either bare or coated on one or both sides. Such sheet product, including foil gauge thicknesses thereof, is suitable for use in making formed food containers, lids and trays, the packaging of certain health-related products like contact lenses, medicines and syringes, and for making industrial sheet products therefrom, including but not limited to non-food containers and lidding, and numerous air handling equipment applications like spiral duct products. The invention further relates to aluminum sheet stock sold in an already lubricated state, ready for further processing. The invention specifically relates to making food-and/or beverage-contacting sheet product from such aluminum alloys as 1050, 1100, 1145, 3003, 3004, 5017, 5042, 5052, 5082, 5182, 5352, 8011 and 8111 aluminum (Aluminum Association designations), said products being made and sold in numerous tempers including but not limited to: O, H19 and H24. An improved lubricant composition for such food and non-food sheet applications is also described herein.

2. Technology Review

The aluminum industry supplies formed container and tray manufacturers with millions of pounds of coiled sheet product each year. These manufacturers convert such sheet product into containers in numerous shapes and sizes. Such sheet products are often coated with a lubricant composition on one or both surfaces by the sheet supplier, with additional lubricant being applied as required by the container and/or tray maker prior to fabrication. The beer and beverage industry also uses substantial quantities of lubricated aluminum product each year in their manufacture of container or can bodies and lidding. Any lubricant residue on food or beverage packaging must meet all applicable U.S. Food and Drug Administration (or “FDA”) requirements. It is also important to address the dietary concerns of certain religious organizations with respect to food packaging.

Liquid and solid lubricants are used in metal working operations to reduce and control friction and wear between the surface of metal being worked and surfaces of the apparatus carrying out a given metal working operation. When suitably formulated and applied, lubricants reduce and control friction and wear by maintaining a thin film of an appropriate composition between the contacting surfaces in relative motion. Lubricants can also improve tooling cleanliness and durability and impart good surface quality to the worked product.

In addition to their friction and wear reducing characteristics, lubricant compositions are expected to fulfill certain other requirements in sheet forming applications. They should: be easy to apply and remove where removal is warranted; afford some protection to the metal surface during handling and storage; present no health hazards to persons coming in contact with the composition; and cause no degradation of the surfaces in contact therewith. For food-contacting packages, lubricant residues should not affect the characteristics of the packaged product. They may help facilitate the initial packaging of foodstuffs in these containers, e.g., by aiding in the spreading of pie dough onto properly lubricated pie pans. In other instances, lubricants help facilitate separation of the food from the formed sheet containers or trays in which such foods are warmed, cooked or baked.

It is known that lubricant compositions can be applied to aluminum sheet products through numerous methods. One representative means employs an electrostatic spray coater or atomizer as set forth in commonly-assigned Grassel U.S. Pat. No. 4,839,202, the disclosure of which is fully incorporated by reference herein. Still other known lubricant application means include dipping the sheet product or passing it through any of various applicators which generate fine droplets of lubricant for deposit on said sheet product with electrostatic assistance, or contacting the sheet with rotating rolls designed to transfer lubricant to the sheet from the roll. One may also incorporate lubricant as a coating component, coming to the surface in the cured coating, as is done for some can lid coatings. It is also known to use various lubricant-rich media, such as felt, over which the sheet may be advanced with lubricant transfer to one or both sides of the sheet. The lubricant composition/blend of this invention can be applied by any of the foregoing means. On a less preferred basis, the lubricant composition of this invention may be added to one or more solvents prior to application of the solvent to the sheet metal, said solvent(s) being suitable for evaporation and recovery for reuse. Representative solvents include hydrocarbons, such as hexane, and other organic solvents. For some sheet products, lubricated materials are further subjected to purposeful processing steps to inpart mostly stylistic, but sometimes functional, improvements to surfaces which the consumer/end user most often sees or utilizes.

Macpherson U.S. Pat. No.5,658,864 uses lower molecular weight polyalphaolefins in a lubricant to reduce its pour point and improve its oxidative and hydrolytic stabilities. In this invention, it is desirable for the vegetable oil portion of the lubricant formulation to polymerize. The PAO component enables a thin film of the polymerized vegetable oil portion to retain a slippery (versus a tacky) consistency. The monounsaturate levels of the vegetable oil components of the Macpherson composition are also above 60%, which is important to minimize oxidation and polymerization in the fluids noted in his invention. In this invention, polymerization of the vegetable oil components is desired. The use of high monounsaturate content, including genetically modified vegetable oils, is not conducive to polymerization and is, therefore, not preferred.

### SUMMARY OF THE INVENTION

It is a principal objective of this invention to provide a lubricant composition for formed container stock and industrial sheet product applications which performs as well as leading compositions with respect to improved friction and wear performance. The polymerized film mentioned above limits or eliminates the tendency of smudge residues, which consist of metal fines and residual rolling lubricants, to transfer to the packaged product. It is another objective to provide container and industrial sheet stock with one or more prelubricated surfaces so as to eliminate, or significantly reduce, the frequency of use and necessary amount of a second, or supplemental, lubricant that is subsequently applied to the stock by the purchaser prior to further fabrication. It is yet another objective to provide a lubricated sheet product and lubricant composition which overcomes the undesirable tendency, over time, for thin layers of certain lubricants to become tacky. Yet another main objective is to provide a liquid lubricant composition to facilitate application onto sheet product and be well suited to application by a variety of methods.

The main components of this lubricant composition are liquids, thereby enhancing its flexibility for application by different methods and allowing for application without the use of solvents. Undesired oxidation can be minimized through the addition of an antioxidant, such as butylated hydroxytoluene (“BHT”), to the composition. The optional introduction of a conductivity-enhancing additive can provide adequate electrical conductivity for applying this lubricant electrostatically to metal being handled at production line speeds of up to 5,000 ft/min. Additions of up to about 10 wt. % lecithin, and/or other ionic materials like salts of fatty acids or phosphate derivatives of glycerides, enable electrostatic application of this invention.

In accordance with the foregoing objectives and advantages, there is provided a metal sheet product, more particularly formed container stock and/or industrial sheet product, which has been treated with a lubricant composition whose vegetable oil components are less than about 60% monounsaturated in character. This composition consists essentially of: (a) about 10-90 wt. % of a technical white mineral oil such as a polyalphaolefin (“PAO”), or a white mineral oil, either oil component having an average molecular weight greater than about 400; and (b) about 10-90 wt. % of an edible vegetable oil, or vegetable oil blend, selected from the group consisting of safflower oil, canola oil, soybean oil, sunflower oil, corn oil, olive oil, cottonseed oil or combinations thereof. Preferably, this polyalphaolefin (or white mineral oil or technical white mineral oil) exhibits low to zero biodegradability, thus minimizing its tendency to degrade over time and minimizing odor generation during prolonged storage. Other edible vegetable oils, or blends with substantial contents of diunsaturated (e.g. linoleic) and/or monounsaturated (e.g. oleic) fatty acid chains, may be suitable substitutes for one or more of the foregoing vegetable oils. With the application of said composition onto sheet at total deposited weights of about 0.1-30 mg/ft² per side, this invention results in food- and non-food contacting sheet products having improved formability and resistance to the loosening or softening of smudge residues.

### DETAILED DESCRIPTION OF PREFERRED EMBODIMENTS

In the following detailed description, repeated reference is made to the application of preferred lubricant compositions to 1000, 3000, 5000 and 8000 Series aluminum sheet products (Aluminum Association designations). On a preferred basis, this lubricant is used on an aluminum alloy that is at least about 95% pure aluminum. It is to be understood, however, that this same composition and resultant sheet product may have other applications to steel and other formed food container and tray products. When referring to relative component percentages, all references are to percent by weight, or abbreviated “wt. %”, unless otherwise expressly indicated.

When referring to “sheet” products herein, such designations are meant to encompass all sheet and foil product thicknesses or gauges, including those higher than 0.006 inch (typically “sheet”) and those 0.006 inch or less (typically “foil”). The lubricant composition of this invention may be applied to one or both sides of substantially planar, aluminum sheet product ranging in overall thickness from about 0.00025-0.0200 inch thick, said sheet product being bare, coated, or of a laminate structure prior to lubricant application. When referring to “food” products, said term is meant to include both liquid and solid foodstuffs, as well as most beer and beverage products. And when referring to “containers” in the claims, and elsewhere throughout the description of this invention, said term is meant to include both containers, trays and the lidding or lidstock for each.

When referring to any numerical value, or range of values throughout this description and accompanying claims, it is to be understood that each range expressly includes every full and fractional number between the stated range maximum and minimum, such that a composition that includes about 10-90 wt. % of a polyalphaolefin would cover any lubricant having 11, 12, 13, 14 or 15 wt. % of that additive, as well as 89.5, 89.7 and 89.9 wt. %, up to and including 89.999 wt. % polyalphaolefin. The same applies to all other numerical compositional and performance ranges set forth herein. In addition, it should be noted that all of the compositional ranges set forth in the accompanying claims are expressly cross-referenced here to establish an antecedent basis therefor.

A first principal component of this invention comprises a polyalphaolefin which is a synthetic base oil, though it is to be understood that one or more technical white mineral oils or white mineral oils with a moderate to high average molecular weight (i.e. greater than about 400) may be fully or partially substituted therefor. This molecular weight value has become critical to this invention in that the use of mineral oils of sufficient viscosity limits lubricant migration. It is undesirable for the lubricant to pool or migrate off the edge of sheet product after it has been applied thereto, as could be the case with many lower molecular weight mineral oils. One suitable version of PAO is sold commercially by Amoco Chemicals as Durasyn® 170. These polyalphaolefins are available in various viscosity levels. For instance, Durasyn® 170 has a viscosity of about 10 centistokes (or “cSt”) as measured at 100° C. Other Durasyn® variants with average molecular weights greater than 400 range in viscosities from as low as about 4 cSt to as high as about 100 cSt or more. Such ranges of viscosities make it possible for customizing formulated lubricant viscosity, optimizing sheet forming performance and/or minimizing lubricant migration (or flow after initial application). It is to be understood that other PAOs may be used in combination with the main lubricant constituents of this invention. Suitable substitutes for Amoco's Durasyn® include: Mobil Chemical Company's Mobil SHF product line of PAOs and Uniroyal Chemical's line of Synton® products. It is to be understood that other desired viscosities may also be effected by blending together two or more of the aforementioned polyalphaolefins. None of these PAO alternatives should be confused with the polybutene-based lubricants of the prior art, however. These primary components are in separate and distinct chemical families. PAO's have become known as a family of hydrocarbons manufactured by the catalytic oligomerization of linear alpha olefins having six or more (usually between 8 and 12) carbon atoms. Polybutenes, by contrast, are produced by the polymerization of a hydrocarbon stream containing a high proportion of isobutylene (non-linear).

Many of the aforementioned polyalphaolefins are derived from decene-1 oligomers. Other suitable products can be manufactured from dodecene- 1 or other alphaolefine precursors. Alternatively, certain white mineral oils as described in 21 C.F.R. §178.3620(a), or technical white mineral oils consisting of refined mineral oils and/or synthetic hydrocarbons, as described in 21 C.F.R. §178.3620(b), the disclosure of which are incorporated by reference herein, may be used as a polyalphaolefin supplement and/or substitute in accordance with this invention. There are also some new developmental polyolefin products which would meet the requirements of 21 C.F.R. §178.3620(b) which may be substituted for the aforementioned PAO's preferred above.

The second principal component hereof is an edible vegetable oil, preferably one high in diunsaturated and/or monounsaturated fatty acid derivatives. Preferred vegetable oil products include one or more of: safflower oil, canola oil, soybean oil, sunflower oil, corn oil, olive oil, and cottonseed oil, with a combination of safflower and canola oil being most preferred. One suitable safflower oil product is sold by Welch, Hohne & Clark Co., Inc. An alternative source is the Hain Food Group, Inc. One suitable canola oil product is also sold by Welch, Holme & Clark Co., Inc. An alternative source is the Procter & Gamble Company. In more preferred embodiments of this invention, it has been determined that the best results, in terms of combinations of properties, have been observed when a combination of safflower oil and canola oil are combined with PAO. Particularly preferred ratios of safflower oil to canola oil in these compositions range from about 1:2 or 1:2.5 to about 1:4. Most preferred properties were observed with a lubricant containing about 1:3 safflower to canola oil. Although the use of vegetable oils as environmentally responsible lubricants in various machining and metalworking fluids is well known (e.g. U.S. Pat. Nos. 4,581,152, 4,775,418, 5,538,654 and 5,681,797), as is their use in pan lubricants for cooking (e.g. U.S. Pat. No. 4,023,912), this is their first known application, in combination with other materials, for sheet lubrication as described herein.

The tendency for thin films of highly unsaturated oils to develop a tacky feel was compared following storage of lubricant-coated metal samples for several weeks under selected conditions. Although tackiness was observed for certain metal surfaces coated with only pure vegetable oils, samples coated with the preferred blends of this invention remained slippery to the touch.

When improved electrostatic application of this lubricant composition is desired, it is preferred that up to about 10 wt. %, and preferably about 1-7 wt. %, of a conductivity enhancer such as lecithin, be added to the foregoing lubricant blend. One representative, commercially available lecithin product is sold by ADM Ross & Rowe Lecithins under the name “Thermolec 57”. Another substitute therefor is sold by Central Soya Company, Inc. as Centrophase® 152. Still another possible supplier of lecithin products is Reichhold Chemicals, Inc., who market their line of Kelecin® products.

For improved oxidation resistance, it has been observed that up to about 2 wt. % of an antioxidant should be included in the aforementioned formula. One suitable example of such, butylated hydroxytoluene, or di-t-butyl-p-cresol, is sold by many suppliers including Rhein Chemie and PMC Specialties. Other suitable antioxidants include butylated hydroxyanisole, a tocopherol; and mixtures thereof.

### Table I—Miniature Cup Die Testing

For 40% drawn miniature cups made from 3003 aluminum alloys, in O. H19 and H24 tempers, the following percentages of cups were successfully formed from sheet product comparatively lubricated with:

| | TEMPER | | |
|---|---|---|---|
| LUBRICANT | O | H19 | H24 |
| 50% Safflower Oil; 50% PAO (Durasyn 170) | 100% | 100% | 100% |
| 100% Safflower Oil | 100% | 100% | 100% |
| 50% Canola Oil; 50% PAO (Durasyn 170) | 90% | 100% | 100% |
| 100% Canola Oil | 54% | 100% | 100% |
| Wax Based Lubricant A | 100% | 100% | 100% |
| Liquid Based Lubricant B | 20% | 80% | 90% |

Formability testing comparisons from the foregoing Table I show that a blend of safflower oil with Durasyn 170, a polyalphaolefin, performed slightly better than canola oil-based blends and was much improved over a commercially used liquid lubricant B.

The tendency to loosen or soften smudge residues was measured by wiping the lubricated surfaces with absorbent cloth soaked with vegetable oil at times of 1 day and 7 days after application of the lubricant to the metal surface. Comparisons of the amount of smudge transferred to the cloth indicated a substantially reduced amount of smudge transfer for the formulations of this invention compared with other liquid formulations.

Table II that follows summarizes preferred compositions for several different, basic applications of lubricants in accordance with this invention. The first has been customized for improved formability and smudge control; the second for improved application to aluminum sheet products; the third for improved oxidation resistance; and the fourth for achieving the benefits of the first three compositions while still maintaining good formability and smudge control performance.

TABLE II
Preferred Lubricant Compositions

| | 1. Improved | 2. 1 and | 3. 1 and | |
|---|---|---|---|---|
| | Formability | Better | Better | |
| | & Smudge | Electrostatic | Oxidation | 4. 1, 2 and 3 |
| Component | Control | Application | Resistance | Combined |
| Polyalphaolefin | 25-75 wt. % | 15-75 wt. % | 23-75 wt. % | 13-75 wt. % |
| Safflower Oil | 5-25 wt. % | 5-25 wt. % | 5-25 wt. % | 5-25 wt. % |
| Canola Oil | 15-60 wt. % | 15-60 wt. % | 15-60 wt. % | 15-60 wt. % |
| Lecithin | | 0-10 wt. % | | 0-10 wt. % |
| BHT | | | 0-2 wt. % | 0-2 wt. % |

The following matrix (Table III) was developed to provide information on odor-related properties as well as relative tackiness of a lubricated metal surface. The samples were stored for 9 days at room temperature, then 7 days at 50° C. prior to evaluation to simulate extended storage conditions. Odor was evaluated by sample comparison with “−” indicating a strong odor, “0” for an intermediate odor, and “+” for a mild odor. Feel was a comparison of relative smoothness evaluated by sliding a finger along the lubricated product surface. The extent of mottling was a visual evaluation of the surface of prelubricated sheet that was stacked, then purposefully separated after the aforementioned storage times. Finally, “sticking on peeling” was evaluated during the separation of the stacked samples used for evaluating mottling. Note, all of the formulations in Table III contained additions of 4 wt. % lecithin and 0.25 wt. % BHT.

TABLE III
Odor and Feel Tests

| | | | Extent of | Sticking on |
|---|---|---|---|---|
| Formulation | Odor | Feel | Mottling | Peeling |
| PAO 10 50%; Saff 25%; | + | smooth | medium | slight |
| Can 25% | | | | |
| PAO 10 50%; Saff 50% | + | smooth | med-high | none |
| PAO 10 50%; Petrolatum 5%, | − | less | med-high | med-high |
| Saff 45% | | smooth | | |
| PAO 10 75%; Saff 25% | o | smooth | med | slight |
| PAO 10 50%; Saff 37.5%, | + | smooth | slight-med | slight |
| Can 12.5% | | | | |
| PAO 10 50%; Saff 12.5%, | o | smooth | slight | none |
| Can 37.5% | | | | |
| PAO 10 25%; Saff 75% | − | smooth | med | slight-med |
| Saff 100% | − | sticky | med-high | med |
| PAO 10 100% | + | smooth | med | trace |

These results show the benefit of adding PAO to counter the stickiness of a pure vegetable oil. The safflower oil, especially at higher levels, tended to demonstrate more odor. The presence of canola oil tended to give a less mottled appearance on peeling apart as well as less stickiness. Coupled with the earlier formability results above, the advantages of formulations combining both safflower and canola oil with PAO are readily apparent. Adding up to about 1% BHT to same enhanced the ability of the formulations of this invention to resist undesirable odor generation from chemical degradation, particularly when metal samples were subjected to about 180 days' storage at about 100° F.

The vegetable oil portions of the lubricant compositions of this invention should be less than about 60% monounsaturated in character. This is due to the fact that vegetable oil portions higher in monounsaturates are less prone to form the polymeric films that help keep smudge from being released, a principal objective of this invention. The preferred compositions of this invention are, by contrast, high in polyunsaturates. While canola oil is about 60% monounsaturated, preferred embodiments herein mix that component with safflower oil which is only about 13% monounsaturated (and about 78% polyunsaturated). Any amount of safflower oil added to the canola oil component of these preferred embodiments brings the monounsaturate levels of these vegetable oil portions below about 60%.

Preferred ratios of main components to the lubricant composition of this invention are: about 25-75 wt. % polyalphaolefin (or technical white mineral oil) and about 25-75 wt. % of a vegetable oil selected from: safflower oil, canola oil and combinations thereof. More preferably, this lubricant contains about 40-60 wt. % of said polyalphaolefin, about 8-20 wt. % safflower oil and about 25-50 wt. % canola oil. Other optionally added components include: about 0.02-2 wt. % butylated hydroxytoluene (more preferably about 0.1-2 wt. % of same) and about 1-7 wt. % lecithin.

Having described the presently preferred embodiments, it is to be understood that the invention may be otherwise embodied by the scope of the claims appended hereto.

What is claimed is:

1. A metal sheet product having a first and second surface at least one of which is lubricated with a composition having a vegetable oil portion which is less than about 60% monounsaturate in character, said composition comprising:
(a) about 10-90 wt. % of a technical white mineral oil, a white mineral oil or combinations thereof, said component having an average molecular weight greater than about 400; and
(b) about 10-90 wt. % of an edible vegetable oil selected from the group consisting of: safflower oil, canola oil, sunflower oil, corn oil, olive oil, cottonseed oil and combinations thereof.

2. The sheet product of claim 1 wherein the metal is an aluminum alloy.

3. The sheet product of claim 2 wherein said alloy is at least 95% pure aluminum.

4. The sheet product of claim 2 wherein said alloy is selected from the group consisting of: as 1050, 1100, 1145, 3003, 3004, 5017, 5042, 5052, 5082, 5182, 5352, 8011 and 8111 aluminum (Aluminum Association designations).

5. The sheet product of claim 1 which is suitable for making into formed containers and lidding for food and health care products.

6. The sheet product of claim 1 which is suitable for making into industrial sheet product selected from the group consisting of non-food containers, lidding and air handling equipment.

7. The sheet product of claim 1 wherein said technical white mineral oil is a polyalphaolefin and said composition contains about 25-75 wt. % of said polyalphaolefin.

8. The sheet product of claim 1 wherein said composition contains about 25-75 wt. % of a vegetable oil selected from the group consisting of: safflower oil, canola oil and combinations thereof.

9. The sheet product of claim 1 wherein said composition contains about 40-60 wt. % of said polyalphaolefin, about 8-20 wt. % safflower oil and about 25-50 wt. % canola oil.

10. The sheet product of claim 1 wherein said composition further contains up to about 10 wt. % of a conductivity enhancer.

11. The sheet product of claim 10 wherein said conductivity enhancer consists essentially of lecithin.

12. The sheet product of claim 1 wherein said composition further contains up to about 2 wt. % of an antioxidant.

13. The sheet product of claim 12 wherein said antioxidant is selected from the group consisting of: butylated hydroxytoluene; butylated hydroxyanisole; a tocopherol; and mixtures thereof.

14. The sheet product of claim 12 wherein said antioxidant consists essentially of butylated hydroxytoluene.

15. The sheet product of claim 1 wherein said composition contains about 40-60 wt. % of said polyalphaolefin; about 8-20 wt. % safflower oil; about 25-50 wt. % canola oil; and about 1-7 wt. % lecithin.

16. The sheet product of claim 15 wherein said composition further contains about 0.02-2 wt. % butylated hydroxytoluene.

17. The sheet product of claim 1 wherein said composition contains about 40-60 wt. % of said polyalphaolefin; about 8-20 wt. % safflower oil; about 25-50 wt. % canola oil; and about 0.02-2 wt. % butylated hydroxytoluene.

18. The sheet product of claim 17 wherein said composition contains about 40-60 wt. % of said polyalphaolefin; about 8-20 wt. % safflower oil; about 25-50 wt. % canola oil; about 0.1-2 wt. % butylated hydroxytoluene; and about 1-7 wt. % lecithin.

19. Formed container stock made from an aluminum alloy having a first and second surface, at least one surface of which has been treated with a lubricant composition having a vegetable oil portion which is less than about 60% monounsaturate in character, said composition consisting essentially of:
(a) about 10-90 wt. % of a technical white mineral oil, a white mineral oil or combinations thereof, said component having an average molecular weight greater than about 400; and
(b) about 10-90 wt. % of an edible vegetable oil selected from the group consisting of: safflower oil, canola oil, sunflower oil, corn oil, olive oil, cottonseed oil and combinations thereof.

20. The container stock of claim 19 wherein said alloy is selected from the group consisting of: 1050, 1100, 1145, 3003, 3004, 5017, 5042, 5052, 5082, 5182, 5352, 8011 and 8111 aluminum (Aluminum Association designations).

21. The container stock of claim 19 onto at least one surface of which about 0.1-30 mg/ft² of said composition has been deposited.

22. The container stock of claim 19 wherein said technical white mineral oil is a polyalphaolefin and said composition contains 25-75 wt. % of said polyalphaolefin.

23. The container stock of claim 19 wherein said composition contains about 25-75 wt. % of a vegetable oil selected from the group consisting of: safflower oil, canola oil and combinations thereof.

24. The container stock of claim 19 wherein said composition contains about 40-60 wt. % of said polyalphaolefin; about 8-20 w t.% safflower oil and about 25-50 wt. % canola oil.

25. The container stock of claim 19 wherein said composition further contains up to about 10 wt. % of a conductivity enhancer.

26. The container stock of claim 25 wherein said conductivity enhancer consists essentially of lecithin.

27. The container stock of claim 19 wherein said composition further contains about 1-7 wt. % lecithin.

28. The container stock of claim 19 wherein said composition further contains up to about 2 wt. % of an antioxidant.

29. The container stock of claim 28 wherein said antioxidant is selected from the group consisting of: butylated hydroxytoluene; butylated hydroxyanisole; a tocopherol; and mixtures thereof.

30. The container stock of claim 28 wherein said antioxidant consists essentially of butylated hydroxytoluene.

31. The container stock of claim 19 wherein said composition contains about 40-60 wt. % of said polyalphaolefin; about 8-20 wt. % safflower oil; about 25-50 wt. % canola oil; and about 1-7 wt. % lecithin.

32. The container stock of claim 31 wherein said composition further contains about 0.02-2 wt. % butylated hydroxytoluene.

33. A lubricant composition for sheet product made from an aluminum alloy, said composition having a vegetable oil portion which is less than about 60% monounsaturate in character, said composition comprising:
(a) about 10-90 wt. % of a polyalphaolefin; and
(b) about 10-90 wt. % of an edible vegetable oil selected from the group consisting of: safflower oil, canola oil, sunflower oil, corn oil, olive oil, cottonseed oil and combinations thereof.

34. The lubricant composition of claim 33 wherein said aluminum alloy is selected from the group consisting of: 1050, 1100, 1145, 3003, 3004, 5017, 5042, 5052, 5082, 5182, 5352, 8011 and 8111 aluminum (Aluminum Association designations).

35. The lubricant composition of claim 33 which contains about 25-75 wt. % of said polyalphaolefin.

36. The lubricant composition of claim 33 which contains about 25-75 wt. % of a vegetable oil selected from the group consisting of: safflower oil, canola oil and combinations thereof.

37. The lubricant composition of claim 33 which contains about 40-60 wt. % of said polyalphaolefin; about 8-20 wt. % safflower oil and about 25-50 wt. % canola oil.

38. The lubricant composition of claim 33 which further contains up to about 10 wt. % of a conductivity enhancer.

39. The lubricant composition of claim 38 wherein said conductivity enhancer consists essentially of lecithin.

40. The lubricant composition of claim 33 which further contains up to about 2 wt. % of an antioxidant.

41. The lubricant composition of claim 40 wherein said antioxidant is selected from the group consisting of: butylated hydroxytoluene; butylated hydroxyanisole; a tocopherol; and mixtures thereof.

42. The lubricant composition of claim 40 wherein said antioxidant consists essentially of butylated hydroxytoluene.

43. The lubricant composition of claim 33 which contains about 40-60 wt. % of said polyalphaolefin; about 8-20 wt. % safflower oil; about 25-50 wt. % canola oil; and about 1-7 wt. % lecithin.

44. The lubricant composition of claim 43 which further contains about 0.02-2 wt. % butylated hydroxytoluene.
